(19) United States
(12) Patent Application Publication
(10) Pub. No.: US 2018/0087432 A1
(43) Pub. Date: Mar. 29, 2018

(54) Method for Diagnosing a Measurement of a Pressure Difference

(71) Applicant: AUDI AG, Ingolstadt (DE)

(72) Inventor: Bodo Odendall, Lenting (DE)

(73) Assignee: AUDI AG, Ingolstadt (DE)

(21) Appl. No.: 15/709,531

(22) Filed: Sep. 20, 2017

(30) Foreign Application Priority Data
Sep. 29, 2016 (DE) 102016218820.8

(51) Int. Cl. F01N 11/00; G01M 15/10

(52) U.S. Cl. CPC F01N 11/002; G01M 15/106

(57) ABSTRACT

A method for diagnosing a measurement of a pressure difference. The measurement is carried out with a measuring arrangement for a component of an exhaust gas device, the input of which is connected to a first exhaust gas pipe and the output of which is connected to a second exhaust gas. The measuring arrangement is provided with a pressure difference measuring device and with a first and second pressure measurement point, which are connected to the pressure difference measuring device for measuring the pressure difference between a pressure measured at the first pressure measurement point and at the second pressure measured at the second pressure measurement point. The pressure difference between the two pressure measurement points is measured with a pressure difference between measuring device.

### FIELD

The invention relates to a method for diagnosing a measurement of a pressure difference and to a system for diagnosing a measurement of a pressure difference.

### BACKGROUND

During the operation of an exhaust gas system for an internal combustion engine of a motor vehicle, different operating parameters may prevail that can be measured during the operation of the exhaust gas system with a measuring arrangement.

The document DE 10 2012 209 538 A1 describes a method for examining the functional reliability of hydraulic structural components in an exhaust gas post-treatment system of an internal combustion engine which operates with a liquid reduction agent and with a reduction agent pump that is operated by means of an electromotor, wherein the reduction agent is supplied from a reduction agent supply container via a reduction agent line to a closed reduction agent injector. The reduction agent pump is turned on for a first, predetermined time period, so that the electric current that is received by the electric motor is determined during that this first time period. After a predetermined standstill period has elapsed, the reduction agent pump is again turned on for a second time period which is identical to the first time period and the electric current received during this time period is detected. The electric currents detected during both time periods are compared with each other and the hydraulic structural components are evaluated downstream of the reduction agent pump with respect to their functional capability on the basis of the result of this comparison.

From the document CN 103267645 A or the document CN 203259345 U are known analytic devices for an exhaust gas stream of an exhaust gas system, which is among other things designed to detect a potential disengagement of an exhaust gas hose of the exhaust gas system.

The document DE 10 2005 005 055 A1 discloses a fault condition detector system for an exhaust gas purification system of an internal combustion engine, wherein a diagnosis of a measurement of a pressure difference is carried out.

A method and a diagnostic unit for diagnosing a differential pressure sensor are described in the document DE 10 2014 209 718 A1. In this case, a differential pressure that is measured with a particle filter is compared during a change of the pressure to an expected differential pressure.

A method for examining a functional state of a sensor is known from the document FR 2 921 723 A3. In this case, the maximum and minimum values of a pressure measurement signals are detected and compared to error thresholds.

Against this background, the task was thus to determine a possible error of a measurement arrangement of an exhaust gas system.

### SUMMARY

This task is achieved with a method and a system that has the features of the disclosure. Embodiments of the method and of the system will become apparent from the dependent claims and from the description.

The method according to the invention is provided for diagnosing a measurement of a pressure difference, for example by examining or monitoring. This measurement is carried out with a measuring arrangement for a structural component of an exhaust gas system, wherein the inlet thereof is connected to a first exhaust pipe and the outlet thereof is connected to a second exhaust pipe. This structural component is provided for post-processing of exhaust gas and it is as a rule designed as a catalytic converter. The measuring equipment is provided with a device which measures the pressure difference and with a first and with a second pressure measurement point, which are connected or should be connected via connecting elements to the pressure difference measuring device for measuring the pressure difference between the pressure that is measured at the first pressure measuring point and the pressure that is measured at the second pressure measurement point, for example by means of hoses or lines. While taking into account the direction in which the exhaust gas flows through the exhaust gas system, the first pressure measurement point for measuring the value of a pressure of the exhaust gas is arranged at the first exhaust gas pipe in front of a structural component, such as a catalytic converter, and the second pressure measurement point for measuring the value of a pressure of the exhaust gas is arranged at the second exhaust gas pipe, behind the structural component, wherein the gas first passes through the first exhaust gas pipe and thus the first pressure measurement point, and then through the second exhaust gas pipe and thus the second measurement point. For each of the exhaust gas pressure waves is thus measured at a first point in time a first value p1 of the pressure difference, and at a second point in time t2 is measured a second value p2 of the pressure difference. In addition, a diagnostic value is calculated as follows: d=(p1−|p2|)/(p1+|p2|).

In this case it is possible to calculate the diagnostic value d also while taking into account a drag indicator, which is formed with asymmetric filtering and which is dependent on the respective values p1, p2 of the pressure difference, wherein the following is valid for the design of d: d=(drag indicator (p1)−|drag indicator (p2)|)/(drag indicator (p1)+|drag indicator (p2)|).

If the result is that d≈−1, an interruption is diagnosed of a connection between the first pressure measurement point in front of the catalytic converter and the pressure difference measuring device. On the other hand, if the result is d≈1, an interruption is diagnosed of a connection between the second measurement point behind the catalytic converter and the pressure difference measuring device.

In this embodiment it is still possible to correct the diagnostic value p2 in comparison to the first value p1 with an expected and/or simulated pressure drop via the catalytic converter. As a rule, the exhaust gas pressure wave will have in the first exhaust gas pipe a first pressure for the pressure in front of the structural component, and a smaller second value is displayed after the structural component in the second exhaust gas pipe, which is reduced in comparison to the first value by this pressure drop. Accordingly, the amount of the measured value p2 of the pressure difference is reduced in comparison to the first value p1 of the pressure difference.

If the result of the calculation is that d≈0, a connection is diagnosed between both pressure measurement points by the pressure difference measuring device.

In an embodiment, the pressure difference is measured for an exhaust gas wave that is flowing along the exhaust gas system from the first exhaust gas pipe through the catalyst to the second exhaust gas pipe at both points in time t1, t2, which is prevalent between both pressure measurement points in the catalytic converter, wherein the both values p1, p2 are established.

Usually, the first value p1 and the amount of the second value p1 are approximately equal. Since the pressure decreases due to the pressure drop during the streaming through the exhaust gas system, this means that the first value p1 is greater than the amount of the second value p2. If the pressure difference measuring device is connected to both pressure measuring points, the diagnosed value d will be approximately 0. If one of the two connections of the pressure difference measuring device to one of the two pressure measurement points is interrupted, one of the two values p1, p2 will assume the value of zero, whereby a diagnostic value of d of approximately −1 or approximately 1 will be established.

In the embodiment, as the first value p1 is measured the positive amplitude of the pressure difference, and as the second value p2 is measured the negative amplitude of the pressure difference.

It may be further also provided that the first value p1 of the pressure difference is determined by means of a first, maximum drag indicator max_Sz and the second value p2 of the pressure difference is determined via a second, minimum drag indicator min_Sz. At the same time, the respective drag indicators max_Sz, min_Sz have a respective constant value p1, p2, wherein each drag indicator max_Sz, min_Sz can be regarded as a constant straight line. Therefore, it is also possible to formulate the diagnostic value of (d=(max_Sz−|min_Sz|)/(max_Sz+|min_Sz|).

In this case, it is possible that when asymmetric filtering is used, the first drag indicator max_Sz may be generated below that falling edge during the course of the pressure difference when asymmetric filtering is applied, and that the second drag indicator min_Sz may be generated above a rising edge during the course of the pressure difference when asymmetric filtering is applied, for example during the course of establishing the second value p2 of the pressure difference.

Accordingly, it is also possible to apply asymmetrical filtering of the falling edge via the first value p1, and to apply asymmetric filtering of the rising edge via the second value p2, and to use the values p1, p2 calculated in this manner in a formula in order to calculate the diagnostic value d.

As was already mentioned, the first value p1 of the pressure difference is measured at the first point in time t, and the second value p2 of the pressure difference is measured at the second point in time t2 according to the first point in time t1. A time difference Δt=t2−t1 thus depends at least on the flow velocity and/or on the operation time of the exhaust gas pressure and on the distance between both pressure measurement points, wherein this distance should be measured along length of the exhaust gas system. The flow velocity depends for example on the operating parameters of the internal combustion engine in which the fuel, for example a hydrocarbon compound such as gasoline or diesel, is being combusted to exhaust gas. It is provided that the time difference Δt between both time points takes into account and depends on the velocity at which the exhaust gas pressure waves pass one after another. The value p1 is therefore obtained for the pressure difference to be measured at the first point in time t1, and for a second point in time t2 is obtained the value p2, wherein the second value p2 is as a rule smaller than the first value p1 due to the pressure drop occurring in the catalytic converter. In this case, the values p1, p2 correspond to the maximum or minimum amplitude of the pressure difference.

The method can be carried out with a measuring arrangement wherein the pressure difference measuring device is connected via a first hose in a first connection with the pressure measuring point in front of the catalytic converter, as well as via a second hose in a second connection with the pressure measuring point after the catalytic converter.

The system according to the invention is designed for diagnosing a measurement of a pressure difference. The measurement is carried out with a measurement arrangement for a structural arrangement of an exhaust gas system, the inlet of which is connected to an exhaust gas pipe and its outlet is connected to a second gas outlet pipe. In this case, the measuring arrangement is provided with a pressure difference measuring device and with a first and a second pressure measurement point, which are connected to the pressure-difference measurement device for measuring the pressure difference between a pressure measured at the first pressure measurement point and a pressure measured at a second pressure measurement point, when the measuring arrangement is in order. The first pressure measurement point is arranged on the first exhaust gas pipe. In addition to a first, maximum value p1, which is measured for an exhaust gas pressure wave at a first point in time t1, a second, minimum value p2 of the pressure difference is measured for the pressure difference at a second point in time t2. The system comprises a control device, which is connected to the pressure difference measuring device and designed to calculation a diagnostic value d=(p1−|p2|)/(p1+|p2|). The control device is designed to generate in the case when d≈−1 an information item about the fact that the connection to the pressure difference measure device or a pressure difference sensor is interrupted in front of the catalytic converter, and to generate in the case when d≈1 an information item about the fact that the connection to the pressure difference sensor is interrupted after the catalytic converter.

This information is provided to a user of the exhaust gas system, connected downstream to an internal combustion engine as a part of the motor vehicle. The control device is adapted to control at least one step of the method.

Usually, the pressure difference measuring device is connected by a hose to both respective pressure measurement points for detecting the exhaust gas wave. At the same time, the measurement of the first value p1 of the pressure difference occur during the measurement at the pressure difference measuring device at the point t1 and the second value p2 of the pressure difference is measured at the second point in time t2. If one of the two hoses should become released from its pressure measurement point or if it should fall off so that the connection between this respective sampling point and the pressure difference measuring device is interrupted, this can be detected with the diagnostic value d. Each pressure measurement point can be provided with an opening in the wall at which the respective hose is arranged.

The method can be carried out for each structural component, for example for each catalytic converter to which said measuring arrangement is assigned, and/or for each measuring arrangement. At the same time, the catalytic converter can be designed for example as a four-way catalytic converter or as a three-way catalytic converter. In addition, the structural component of the catalytic converter can be provided with a filter in an exhaust gas system, and an internal combustion engine which is designed for example as a system for a gasoline engine can be arranged so that it combusts for example gasoline as a fuel.

As a rule, an installation test and also the determination of the soot and ash load of the catalytic converter, or of a filter of the catalytic converter that is built as a particle filter, is carried out in order to determine both values of the pressure difference or of the pressure delta value via the filter. The effect that can in this case occur with an internal combustion engine is that a volume stream of the exhaust gas does not flow continuously. However, according to the embodiment, each so-called outlet impact occurring during the opening of the outlet valve of this cylinder, or a pressure wave and/or mass stream wave of the exhaust gas, which can be also referred to an exhaust gas wave, streams through the exhaust gas device or exhaust gas system.

These gas pressure waves first arrive at the first point in time t1 in front of the catalytic converter and depending on the velocity of the exhaust gas pressure wave and on the distance between the respective pressure measurement points, they will then arrive at the second point in time the area after the catalytic converter. Therefore, the measuring device or a corresponding sensor is designed for example to measure the pressure difference measured as the pressure difference that is formed by the positive value of delta p at the point in time t1, and the negative value p2 is then measured at the second point in time t2.

An amount |p2| of the second value p2 of the pressure difference or of an amplitude of the pressure difference is due to the pressure drop of the pressure difference through and/or along the catalytic converter is smaller than an amount |p1| of the first value p1 or of an amplitude of the pressure difference. A value of the drop of the pressure difference is determined with a difference of the amount |p1| of the first value p1 and with the amount |p2| of the second value p2. The value of the drop will thus be determined in this case. When a respective hose which creates a connection with the pressure difference measuring device has fallen off and the connection between a between the pressure difference measuring value and the respective exhaust gas pressure measuring point is thus interrupted, the result is a shift of the determined value of the decrease of the value of the differential pressure determined through the catalyst.

In order to detect an interrupted connection and thus the fact that the hose has fallen off, a detected signal of the pressure difference is generated with asymmetric filtering only for a falling flank of a first drag indicator above the first value p1 so that the maximum positive amplitude of the pressure difference is thus generated and/or formed. Accordingly, if the pressure difference is created via a detected signal, the asymmetric filtering is used only for a rising edge with a second drag indicator above the second value p2 and the maximum negative amplitude of the pressure difference is thus generated and/or formed in this manner. As a rule, both drag indicators are formed over the course of the pressure difference.

A filter constant corresponds to a one-digit or a two-digit multiple, which is about five times to twenty times the equivalent of the time interval between two ignitions of the internal combustion engine. At the same time, the time interval is dependent as an operating parameter of the internal combustion engine on at least one other operating parameter of the internal combustion engine, such as for example a rotational speed.

In the embodiment, the first value p1 can be also referred to and/or formed as the maximum value max_Sz of the drag indicator. Accordingly, the formula for the alternative diagnostic value can be created as: d=max_Sz−|min_Sz|)/max_Sz+|min_SZ|).

Optionally, in the numerator of a fraction of the formula can be also added a model value of the drop in the pressure difference over the catalytic converter, which can be as a rule added to the filter of the catalytic converter. The diagnostic value d or the calculation value thus normalizes an average drop of the pressure between the first value p1 as a maximum peak and the second value p2 as a minimum peak. When both connecting elements are formed for example as hoses that are inserted in both pressure measuring points or sampling point into the exhaust gas pipes, the resulting diagnostic value obtained can be approximately 0, which means that an amount |d| of the diagnostic value d is significantly smaller than 1, namely for example smaller than 0.5.

Accordingly, the diagnostic value d can be smaller than 0.5 and greater than or equal to −0.05. When the first front hose is not inserted into the first sampling point, the resulting calculated value is obtained as a diagnostic value d in the range around −1, which is to say as a rule smaller than −0.5. When the rear, second hose is not inserted into the second sampling point, the resulting calculated value that is obtained as a diagnostic value d is in the range of approximately 1, which is to say greater than 0.5. A unique identification of a hose which is not inserted after the catalytic converter is thus rendered possible. The magnitude of a respective diagnostic value depends on the pressure drop of the exhaust gas wave within the catalytic converter.

Further advantages and embodiments of the invention will become apparent from the description and from the attached drawings.

It goes without saying that the features mentioned above and that that are still to be explained can be used not only in the respective indicated combinations, but also in other combinations or in a single setting, without deviating from the scope of the present invention.

### BRIEF DESCRIPTION OF DRAWINGS

The invention will now be explained based on the embodiments that are schematically indicated in the figure and it will be described in detail with reference to the figures.

FIG. 1 shows in a schematic representation an example of a measuring arrangement for an exhaust gas system and an embodiment of the system according to the invention.

FIG. 2 shows a first diagram and a second diagram of an operating parameter which are taken into account in an embodiment of the method according to the invention.

The figures are described in a coherent and comprehensive manner and the same components are labeled with the same reference numerals.

### DETAILED DESCRIPTION OF DRAWINGS

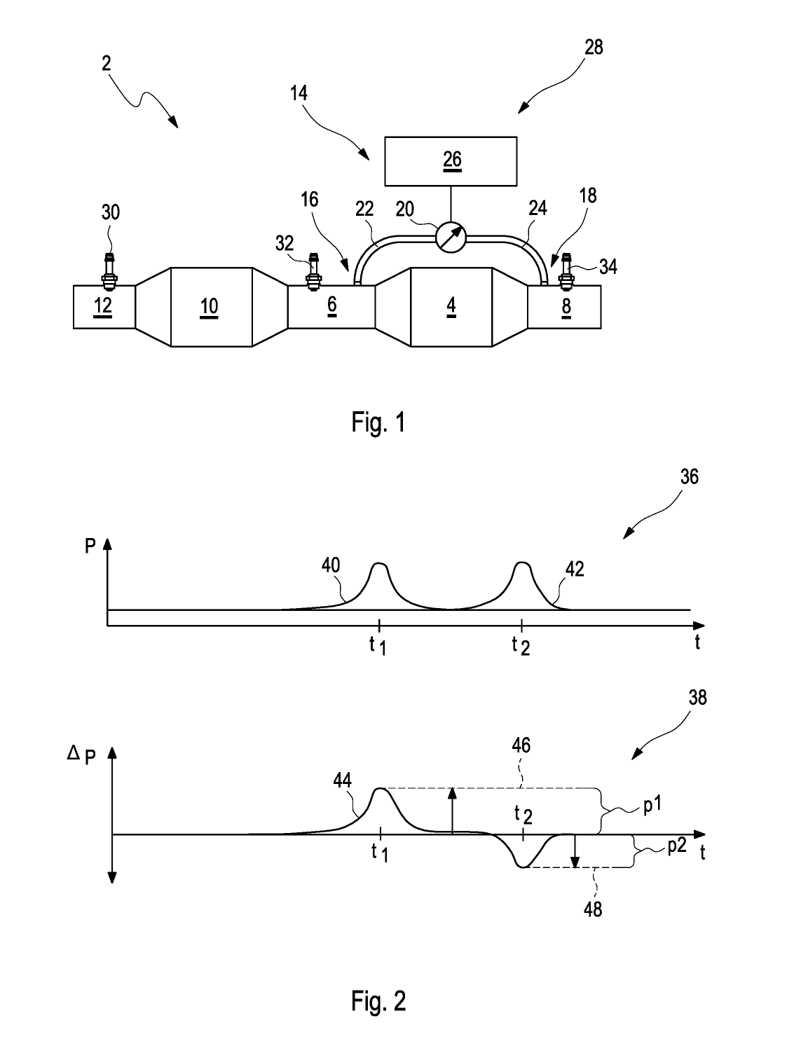

The exhaust system 2 shown by way of an example in FIG. 1 comprises as components a first catalytic converter 4, which is here designed as a four-way catalytic converter and provided with at least one filter. In this case, the catalytic converter 4 is arranged between a first exhaust gas pipe 6 and a second exhaust gas pipe 8. Further, the exhaust system 2 comprises a second catalytic converter 10, here a three-way converter, which is arranged between another exhaust gas pipe 12 and the first exhaust gas pipe 6

The exhaust system 2 is here connected downstream of an internal combustion engine of a motor vehicle by which gasoline or diesel fuel is combusted as fuel here. Exhaust gas which is generated by combusting the fuel in the combustion chamber, usually in cylinders, by the internal combustion engine, flows successively through the exhaust gas pipe 12, the second catalytic converter 10, the first exhaust gas pipe 6, the first catalytic converter 4 and the second exhaust gas pipe 8, wherein the exhaust gas is purified in each of the catalytic converters 4, 10.

FIG. 1 also shows an example of the measuring arrangement 14 which is provided with a pressure measurement point 16, which is arranged at the first exhaust gas pipe 6 in front of the catalytic converter 4, and a second pressure measurement point 18, which is arranged at the second exhaust gas pipe behind the first catalytic converter 4. In addition, the measuring arrangement 14 comprises a pressure difference measuring device 20, which is designed as a differential pressure measuring device 20 and which is connected via a first hose 22 with the first pressure difference measuring point 16 and via a second hose 24 that is used as a connecting element to the second pressure measuring point 18.

The components of the measuring arrangement 14 listed above can be also designed as components of the exhaust gas system 2. FIG. 1 shows in addition a control device 26, which is designed as a component of the system 28 according to the invention, wherein the control device 26 is adapted to control at least one step of the method according to the invention. The control device 26 can be designed and/or referred to depending on the definition as a component of the measuring arrangement 14 and/or of the exhaust gas system 2.

Further, FIG. 1 shows a linear lambda probe 30 arranged on the other exhaust gas pipe 12, a binary lambda probe 32 arranged on the first exhaust gas pipe 6, and an additional binary lambda probe 34 which is arranged on the second exhaust gas pipe 8.

Both diagrams 36, 38 of FIG. 2 include a horizontal axis on which are plotted the values of time t, wherein both horizontal axes are here synchronous with one another and have the same origin. Along the vertical axes of the first diagrams 36 are plotted in the graph the values of the pressure p. It can be seen from this that the exhaust gas pressure wave is present or can be found at a first point in time t1 in front of the catalytic converter 4 and at a second point in time after the catalytic converter.

The value of the pressure difference results from the position of the first pressure measuring point 16 in front of the catalytic converter 4 minus the pressure of the position of the second pressure measuring point after the catalyst 4 and it is plotted along the vertical axis of the second diagram 38.

After each discharge of the exhaust gas from a combustion chamber of the internal combustion engine, a pressure wave of the exhaust gas flows from the internal combustion engine through the exhaust system 2 and passes successively through the exhaust gas pipe 6, the first catalytic converter 4 and the second exhaust gas pipe 8.

For this purpose, the first diagram 36 shows a first course 40 of the pressure of the exhaust gas pressure wave, which is prevalent inside the first exhaust gas pipe 6 and which is detected at the first gas pressure measuring point 16. The first diagram 36 further shows a second course 42 of the pressure of the exhaust gas pressure wave which is prevalent inside the second exhaust gas pipe 8 and which is detected via the pressure measurement point 18. At the same time, a maximum amplitude of the first course 40 of the pressure is detected via the first pressure measurement point 16 at the first point in time t1. A maximum or a maximum amplitude of the second course 42 of the pressure is detected via the second pressure measurement point 18 at a second point in time t2 after the first point in time t1. A difference Δt between the two points t1 and t2 depends on the distance between the two pressure measurement points 16, 18 and a velocity of the exhaust gas pressure wave, which in turn depend on at least one operating parameter of the internal combustion engine, for example a rotational speed of the internal combustion engine, a density and/or a temperature of the exhaust gas.

The second diagram 38 includes a course 44 of the pressure difference, which is measured with the pressure difference measuring device 20 between the two pressure measurement points 16, 18. In this case, the second diagram 38 shows that the pressure difference of the pressure difference wave displays a maximum positive value p1 or a maximum positive amplitude at the first point in time p1, and a minimum is displayed at a second point t2 with a maximum negative value p2 or a maximum negative amplitude.

In this case, the maximum positive value p1 of the pressure difference is determined via a first, maximum drag indicator 46, and the minimum value p2 of the pressure difference is determined via a second, minimum drag indicator 48. In this case it is provided that the first drag indicator 46 is generated with an asymmetric filter via a falling edge of the course 44 of the pressure difference, and the second drag indicator 48 is generated with an asymmetric filter via a rising edge of the course 48 of the pressure difference.

A diagnostic value is calculated with the first, maximum value p1 of the pressure difference, and with the second, wherein a minimum value p2 of the pressure difference is calculated as:

d=(p1−|p2|)/(p1+|p2|)

As is schematically indicated in FIG. 1, both pressure measurement points 16, 18 are connected via hoses 22, 24 as connecting elements with the pressure difference measuring device 20 when the measuring arrangement 14 is correctly arranged and/or installed. If the result during the operation of the measuring arrangement 14 is that d≈-1, a connection of the first pressure measurement point 15 to the pressure difference measuring device 20 is interrupted, which may be due to the fact that the first hose 22 has been loosened. In this case, p1≈0. If the result is that d≈1, a connection of the second pressure measurement point 16 with the pressure measuring device 20 has been interrupted, which may be due to the fact that the second hose 24 has been loosened. In this case, p2≈0. If d≈0, both pressure measurement points 22, 24 are correctly connected to the pressure difference measuring device 20. In this case, 1≈|p2|. Usually, p1 is slightly larger than |p2|.

A difference between p1 and |p2| is dependent on a pressure drop of the exhaust gas pressure wave when it passes through the catalytic converter 4, while such a pressure drop can be also generated when the pressure difference measuring device 20 is connected to both pressure measurement point 16, 18. The pressure drop is as a rule a few percent, for example 10%. If both hoses 22, 24 are correctly connected to both exhaust gas pipes 6, 8 and the diagnostic value is approximately 0, this means that −x≦d≦x, wherein 0<x<1. If the connection to the first pressure measurement point 16 is interrupted, then d<−x and if the connection to the second pressure measurement point is interrupted, then d>x. In this case, x can be for example 0.5 depending on the pressure drop of the exhaust gas wave in the catalytic converter.

1-9. (canceled)

10. A method for diagnosing a measurement of a pressure difference, comprising:
the measurement is carried out with a measuring arrangement for a component of an exhaust gas system, the input of which is connected to a first exhaust gas pipe and the output of which is connected to a second exhaust gas pipe, wherein the measuring arrangement is provided with a pressure difference measuring device and with a first and a second pressure measurement point, which are connected to a pressure difference measuring device for measurement of the pressure difference between a pressure measured at the first pressure measurement point and a pressure that is measured at the second pressure measurement point, wherein the first pressure measurement point is arranged at the first exhaust gas pipe and the second pressure measurement point is arranged at the second exhaust gas pipe, wherein the pressure difference between the two pressure measurement points is measured with the pressure difference measuring device, wherein a first, maximum value p1 is measured for an exhaust gas pressure wave at a first point in time t1, and a second, minimum value p2 of the pressure difference is measured at a second point in time p2, wherein a diagnostic value is calculated as:
d=(p1−|p2|)/(p1+|p2|)
wherein in the case when d is approximately equal to −1, an interruption of a connection to the first pressure measurement point is diagnosed by the pressure difference measuring device, and wherein in the case when d is approximately equal to 1, an interruption of a connection of the second pressure measurement point to the pressure measuring device is diagnosed.

11. The method according to claim 10, which is carried out by the measuring arrangement, wherein the component is a catalytic converter.

12. The method according to claim 10, wherein in the case when d is approximately equal to 0, a connection is diagnosed of both pressure measurement points to the pressure difference measuring device.

13. The method according to claim 16, wherein an amount of a maximum of an amplitude of the pressure difference is measured as the first value p1, and an amount of a minimum of the amplitude of the pressure difference is measured as the second value p2.

14. The method according to claim 10, wherein the first value p1 of the pressure difference is determined with a first, maximum drag indicator max_Sz, and the second value p2 of the pressure difference is determined with a second, minimum drag indicator min_Sz.

15. The method according to claim 14, wherein the first drag indicator max_Sz is determined with an asymmetric filter of a falling edge of a course of the pressure difference, and the second drag indicator min_Sz is determined with an asymmetric filter of a rising edge of the course of the pressure difference.

16. The method according to claim 10, which is carried out with the measuring arrangement (14), wherein the pressure difference measuring device (20) is connected via a first hose (22) to the first pressure measurement point (16) and via a second hose (24) to the second pressure measurement point (18).

17. The method according to claim 11, wherein the second point p2 adjusts the pressure difference as a function of the first value p1 minus a pressure drop in the catalyst (4).

18. A system for diagnosing a measurement of a pressure difference, comprising:
a measuring arrangement for a component of an exhaust gas system, of which the input is connected to a first exhaust gas pipe and the output of which is connected to a second exhaust gas pipe, wherein the measuring arrangement is provided with a pressure difference measuring device and a first as well as a second pressure measurement point, which are connected to the pressure difference measuring device for measurement of the pressure difference between the pressure measured at a first pressure measurement point and the pressure measured at the second pressure measurement point, wherein the first pressure measurement point is arranged at the first exhaust gas pipe and the second pressure measurement point is arranged at the second exhaust gas pipe, wherein a first, maximum value p1 of the pressure difference is measured for an exhaust gas pressure wave at the first pressure measurement point at a first point in time t1, and a second, minimum value p2 of the pressure difference is measured at a second point in time t2, wherein the system is provided with a control device, which is connected to the pressure difference measuring device and which is adapted to calculate a diagnostic value:
d=(p1−|p2|)/(p1+|p2|)
wherein the control device is adapted to generate in the case when d approximately equal to −1 information about the fact that a connection of the first pressure measurement point or pressure measurement point to the pressure measurement measuring device is interrupted, and in the case when d approximately equal to 1 to generate information about the fact that a connection of the second pressure measurement point to the pressure measuring device is interrupted.
